(19) United States
(12) Patent Application Publication
(10) Pub. No.: US 2013/0232471 A1
(43) Pub. Date: Sep. 5, 2013

(54) Method and Apparatus for Assessing Software Parallelization

(71) Applicants: Thomas Henties, Feldkirchen-Westerham (DE); Tobias Schüle, Munchen (DE)

(72) Inventors: Thomas Henties, Feldkirchen-Westerham (DE); Tobias Schüle, Munchen (DE)

(21) Appl. No.: 13/884,994

(22) PCT Filed: Oct. 27, 2011
(86) PCT No.: PCT/EP11/68861

§ 371 Date: May 13, 2013

(30) Foreign Application Priority Data
Nov. 11, 2010 (DE) 10 2010 043 782.4

(51) Int. Cl. G06F 9/45

(52) U.S. Cl. CPC G06F 8/45
USPC 717/124

(57) ABSTRACT

A method for assessing software parallelization may include the steps of analyzing the structure of a software code, splitting the software code into a multiplicity of code portions based on the structure of the software code, ascertaining a complexity value based on the analysis of the structure of the software code for each of the multiplicity of code portions, ascertaining an effort value based on the complexity value for each of the code portions, wherein the effort value indicates the effort required for parallelizing the code potion, and ascertaining an efficiency value for each of the multiplicity of code portions, wherein the efficiency value assesses the efficiency of parallelization of each of the multiplicity of code portions based on a ratio between the ascertained effort value and a useful value which indicates the expected performance gain as a result of the parallelization of the respective code portion.

### CROSS-REFERENCE TO RELATED APPLICATIONS

This application is a U.S. National Stage Application of International Application No. PCT/EP2011/068861 filed Oct. 27, 2011, which designates the United States of America, and claims priority to DE Patent Application No. 10 2010 043 782.4 filed Nov. 11, 2010 The contents of which are hereby incorporated by reference in their entirety.

### TECHNICAL FIELD

The present disclosure relates to a method and an apparatus for assessing software parallelization.

### BACKGROUND

Software is often programmed sequentially, which means that the commands of the program generated from the software code are executed one after another in a single thread or process. However, modern-day computers having a plurality of processors or processor cores possess the capability in principle to execute multiple threads or processes concurrently and consequently to bring about a considerable shortening of the total computing time required for running a program.

In order to benefit from the aforesaid advantages of parallel program execution in such computers having a plurality of processors or processor cores it is necessary to parallelize existing programs or, more specifically, their underlying software code, which is to say to rewrite the code in such a way that concurrent execution in multiple threads or processes is possible free of conflicts and deadlocks.

Parallelizing existing software code is a time-consuming task. With extensive code in particular, an enormous investment of time and effort is required in order to parallelize the software code in its entirety. One possibility for parallelizing software code is full automation of the parallelization process. However, automatic parallelization is often difficult to achieve, because the parallelization rules must be strictly observed in order to avoid conflicts and deadlocks. This can result in only simple portions of the software code that can be analyzed statically being able to be parallelized automatically.

It is therefore desirable to make more complex portions of the software code also amenable to manual parallelization.

FIG. 1 shows a profiler device 100 by means of which an expected benefit of a parallelization can be estimated. A software code 10 is compiled by a compiler 11 and output as an executable program 12. A profiler 13 then calculates from the program 12 the time gain that would result if a parallel execution of the program 12 were to be performed instead of the sequential execution. For this purpose the profiler 13 refers to input data 14 representing typical inputs. The profiler 13 outputs the calculated information 15 relating to the time gain that is to be expected in the event of a parallelization of the program 12. Based on the calculated information 15 a programmer can then decide whether to undertake a parallelization of the software code 10 or not.

A problematic aspect in the approach shown in FIG. 1, however, is that the decision of the programmer in relation to the parallelization is based only on the benefit that is to be expected. It may be possible in this case that the information 15 indicates that a high level of benefit will result from a parallelization of a specific portion of the software code 10, although the programming effort required in order to realize the parallelization of said code portion is disproportionately high.

In order to minimize the overall effort required on the part of the programmer undertaking the parallelization it is necessary to furnish the programmer with criteria based on which he/she can estimate the cost-benefit ratio applicable to the parallelization of portions of the software code and prioritize the investment of time and effort accordingly.

### SUMMARY

One embodiment provides a method for assessing software parallelization, comprising the steps of: analyzing the structure of a software code; subdividing the software code into a plurality of code portions based on the structure of the software code; determining a complexity value based on the analysis of the structure of the software code for each of the plurality of code portions; determining an effort value based on the complexity value for each of the code portions, the effort value indicating the effort required in order to parallelize the code portion; and determining an efficiency value for each of the plurality of code portions, the efficiency value rating the efficiency of a parallelization of each of the plurality of code portions based on a ratio between the determined effort value and a useful value indicating the expected performance gain resulting from the parallelization of the respective code portion.

In a further embodiment, the complexity value comprises a count of the lines of code, a cyclomatic complexity value and/or a function point analysis value.

In a further embodiment, the useful value is dependent on the time saving, the reduction in latency time, and/or the data throughput in the event of the parallel execution of the respective code portion.

In a further embodiment, the useful value is provided by a profiler.

Another embodiment provides an apparatus for assessing software parallelization comprising an analysis device which is configured for analyzing the structure of a software code and subdividing the software code into a plurality of code portions based on the structure of the software code; a calculation device which is configured for determining a complexity value based on the structure of the software code for each of the plurality of code portions and determining an effort value based on the complexity value for each of the code portions, the effort value indicating the effort required in order to parallelize the code portion; and an assessment device which is configured for outputting an efficiency value for each of the plurality of code portions, the efficiency value rating the efficiency of a parallelization of each of the plurality of code portions based on a ratio between the determined effort value and a useful value indicating the expected performance gain resulting from the parallelization of the respective code portion.

### BRIEF DESCRIPTION OF THE DRAWINGS

Exemplary embodiments will be explained in more detail below based on the schematic drawings, wherein:

FIG. 1 is a schematic diagram illustrating a profiler device;

FIG. 2 is a schematic diagram illustrating an apparatus for assessing software parallelization according to one embodiment of the present disclosure;

FIG. 3 is a cost-benefit diagram according to another embodiment of the present disclosure; and

FIG. 4 is a schematic diagram illustrating a method for assessing software parallelization according to another embodiment of the present disclosure.

The drawings are intended to impart a further understanding of the example embodiments. They illustrate example variants and serve in conjunction with the description to explain principles and concepts of the invention. Other embodiment variants and many of the cited advantages will become apparent in reference to the drawings, where like reference signs designate like or like-acting components.

### DETAILED DESCRIPTION

A concept of embodiments disclosed herein includes splitting the software code into portions corresponding to the code structure and, for each of the code portions, assessing the complexity of the code portion. Based on the complexity of the code and the benefit that is to be expected, a cost-benefit ratio can be determined for each of the code portions and can serve as an assessment criterion for the prioritization of parallelizations.

Thus, some embodiments provide a method for assessing software parallelization may include the steps of: analyzing the structure of a software code; subdividing the software code into a plurality of code portions based on the structure of the software code; determining a complexity value based on the analysis of the structure of the software code for each of the plurality of code portions; determining an effort value based on the complexity value for each of the code portions, the effort value indicating the investment of time and effort required in order to parallelize the code portion; and determining an efficiency value for each of the plurality of code portions, the efficiency value rating the efficiency of a parallelization of each of the plurality of code portions based on a ratio between the determined effort value and a useful value indicating the expected performance gain resulting from the parallelization of the respective code portion. This method offers the advantage of providing quantitative information concerning the cost-benefit effect of a parallelization of software code portions in order thereby to give a programmer wanting to parallelize the software code a decision aid for determining at which points in the software code a parallelization promises the greatest benefit to be expected for the least investment of effort.

The complexity value advantageously comprises a lines-of-code count, a cyclomatic complexity value and/or a function point analysis value. This affords the advantage that the cost-benefit forecast of the assessment method is based on quantifiable complexity criteria for the respective software code.

The useful value may be dependent on the time saving, the reduction in latency time, and/or the data throughput in the event of the parallel execution of the respective code portion. This enables the benefit that is to be expected from a parallelization to be referred to quantifiable temporal values. These values may be provided by a profiler device.

According to a further embodiment, the apparatus for assessing software parallelization comprises: an analysis device which is configured for analyzing the structure of a software code and dividing up the software code into a plurality of code portions based on the structure of the software code; a calculation device which is configured for determining a complexity value based on the structure of the software code for each of the plurality of code portions and for determining an effort value based on the complexity value for each of the code portions, the effort value indicating the investment of time and effort required in order to parallelize the code portion; and an assessment device which is configured for outputting an efficiency value for each of the plurality of code portions, the efficiency value rating the efficiency of a parallelization of each of the plurality of code portions based on a ratio between the calculated effort value and a useful value indicating the anticipated performance gain resulting from the parallelization of the respective code portion.

The embodiments and developments described herein can be combined with one another as desired, insofar as this is beneficial. Other possible embodiments, developments and implementations also include combinations, not explicitly cited, of features described herein in relation to the disclosed example embodiments.

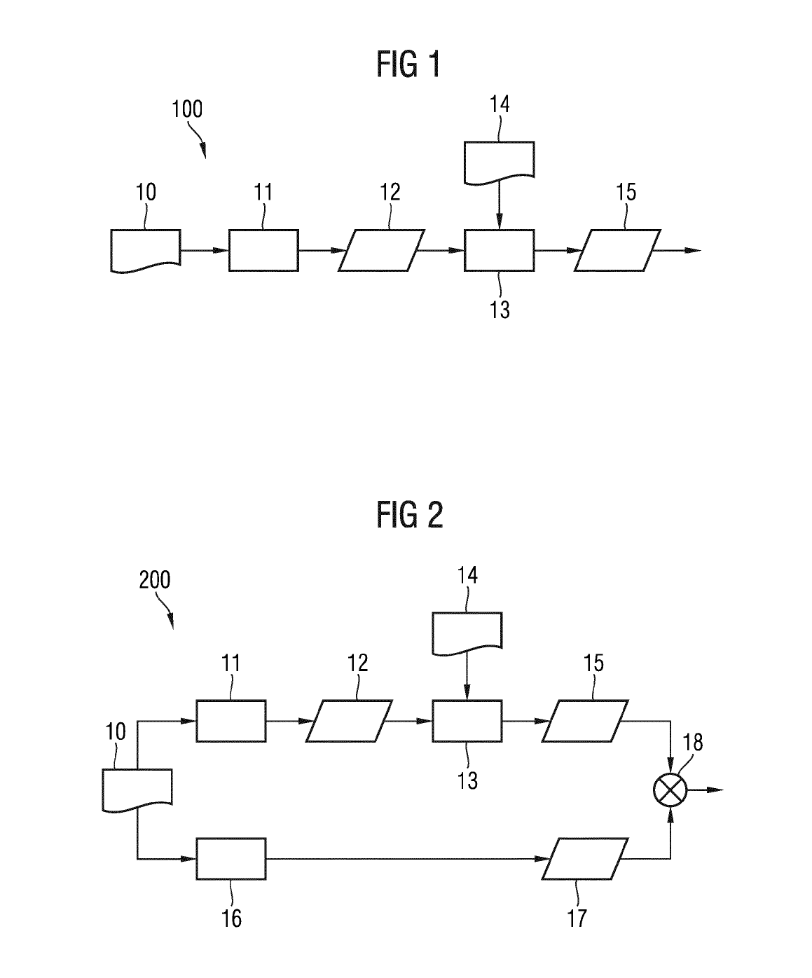

FIG. 2 is a schematic diagram illustrating an apparatus 200 for assessing software parallelization according to an example embodiment. As already explained in connection with FIG. 1, the apparatus 200 comprises a compiler 11 which compiles a software code 10 and outputs same as an executable program 12. A profiler 13 then calculates from the program 12 the time gain that would result if a parallel execution of the program 12 were to be performed instead of the sequential execution. For that purpose the profiler 13 makes use of input data 14 representing typical inputs. The profiler 13 outputs the calculated information 15 relating to the time gain that is to be expected in the event of a parallelization of the program 12.

In addition to the compiler 11, the apparatus 200 includes an analysis device 16 which analyzes the structure of the software code 10 and subdivides the latter into code portions corresponding to the structure. In this arrangement the analysis device 16 can include a calculation device which determines one or more complexity values 17 of the respective code portions. Effort values indicating an estimation of the effort required in order to parallelize the respective code portion can then be determined from the complexity values 17. The information 15 ascertained by the profiler 13 is combined in an assessment device 18 with the complexity values 17 or effort values of the calculation device or the analysis device 16 in order to determine an efficiency value for each of the code portions. In this case the efficiency value can estimate the efficiency of a parallelization of each of the plurality of code portions based on a ratio between the determined effort value and a useful value indicating the expected performance gain resulting from the parallelization of the respective code portion. The useful value can in this case be included in the information 15, and the effort value can be determined from the complexity values 17. The resulting output of the assessment device 18 is a metric for a cost-benefit ratio that is to be expected for each of the code portions in the event of a possible parallelization.

It may be possible to examine only specific portions of the software code 10 in relation to the efficiency of a parallelization. For example, code portions which have already been parallelized or in the case of which a parallelization is undesirable can be excluded from consideration. It may furthermore be possible for the apparatus 200 to include only the analysis device 16 and the assessment device 18, and for the corresponding information 15 to be provided by an external profiler device 100, such as is illustrated in FIG. 1 for example.

Exemplary embodiments illustrating how the complexity values 17 in FIG. 2 can be determined are explained hereinbelow. It should be clear that the complexity criteria, variables, calculation formulae and numeric values shown here are merely exemplary in nature, and that there are a multiplicity of possible ways in which the complexity values 17 can be determined from the software code 10 or, as the case may be, the structure of the software code 10.

The effort values which can be determined based on the complexity values 17 are likewise explained in more detail with reference to exemplary embodiments. It is to be understood, however, that a multiplicity of other calculation and/or determination possibilities exist which can be applied just as well as the following calculations.

Various criteria can be applied in order to determine the complexity of a software code or the structure of a software code, for example the number of lines of software code in the code portion under consideration, with or without dependent calls, the cyclomatic complexity, function point analysis values, COCOMO (constructive cost model, an algorithmic effort model), parallelization probabilities, conflict probabilities, and the like.

Cyclomatic complexity is a metric for the complexity of the control flow of a code portion which takes account of the number of binary branches within the control flow graph of the code portion. The higher the number of binary branches, the greater will be the value estimated for cyclomatic complexity.

Function point analysis values can be determined through dissection of a code into logical data types and elementary processes and subsequent determination of the functional scope through evaluation of the elementary processes in connection with the logical data types. Depending on the complexity of the code portions, the system can therefore be subdivided into complexity levels.

Parallelization probabilities can be determined using heuristic methods with relaxed parallelization requirements. Strict parallelization requirements require a definitive absence of data dependencies between the processes that are to be parallelized so that in an automated parallelization, for example, an occurrence of data access conflicts can be definitively ruled out. These parallelization requirements can be relaxed to the extent that without definite knowledge it will initially be assumed that no data dependencies exist between processes that are to be parallelized unless there is evidence to the contrary. This enables parallelization probabilities to be specified which express a conclusion as to how probable it is whether a parallelization of the corresponding processes will lead to data conflicts.

A parallelization probability can be set to 0 for example if there are data dependencies which cannot be resolved by standard transformations or compilation optimizations such as loop unrolling (loop splitting and/or loop peeling). The parallelization probability can be set to 1 if for example no dependencies exist between different loop iterations. Values between 0 and 1 can be assigned to parallelization probabilities when for example different data types are involved, though an overlapping of the data in the memory cannot be positively ruled out, or when no data dependencies are known to date.

In order to determine effort values, one or more of the above-described complexity criteria can be utilized and combined, taking into account different weightings. For example, the complexity of a code can be formed by the product from the number of lines of code (LoC) and the cyclomatic complexity.

In the following example an effort value E is formed via a product derived from static complexity C, i.e. the complexity of the code structure, and parallelization probability P:

E=C*(1−P)

In this case individual values for the complexity C and the parallelization probability P are initially collected for the subcomponents of the code and suitably combined in order then to determine the effort value E for the code in its entirety or for the code portion in its entirety.

Various parameters can be called upon in order to calculate the performance gain that is to be expected from a parallelization of a code or code portion, for example the speed increase of the overall system or of the respective execution of the program segment under consideration, the reduction in latency time, or the data throughput. In an example shown here the performance gain S that is to be expected can be calculated as the ratio between an original runtime tₒ for a sequential execution of the program segment under consideration and a sum formed from the runtime tₚ during the parallel execution of program sections and the runtime tₛ during the remainder of the sequential execution of the remaining program segments:

S=tₒ/(tₛ+tₚ)

Information about the number of available parallel processors and/or assumptions concerning data dependencies can be used in order to calculate the runtime values tₒ, tₚ and tₛ. In this case the number of processors can be a predefined fixed natural number or can be infinite for theoretical considerations. It can furthermore be provided to include in the calculation of the runtime values tₒ, tₚ and tₛ the values of the parallelization probability P for the individual code portions as well, for example by assuming for code portions having a parallelization probability P below a certain threshold value that in principle these code portions are not suitable for parallelization and will be assigned the original runtime tₒ for the sequential runtime tₛ, in other words that the runtime gain will be set equal to 0.

In the present example an efficiency value F can then be determined from the ratio of the effort value E and the performance gain S that is to be expected:

F=(S−1)*100/E

In this example the efficiency value F can assume values between 0 and infinity, where a high value of F designates code portions in which the cost-benefit ratio in the event of a parallelization is estimated as high. A ranking of code portions can then be carried out as a function of their efficiency value F, whereupon the parallelization can be prioritized by a programmer in accordance with the rankings.

Table 1 lists by way of example the corresponding runtimes tₒ, tₛ and tₚ in seconds, the complexity values C in number of lines of code (LoC), the parallelization probabilities P, the effort values E, the performance gains S that are to be expected, and the efficiency values determined for different code portions, in this case functions W, X, Y and Z.

TABLE 1

| | Function | | | | | | | |
|---|---|---|---|---|---|---|---|---|
| | Profiling | | Effort | | | Benefit | | Efficiency |
| Name | tₒ [s] | tₛ [s] | C [LoC] | P | E | tₚ [s] | S | F |
| W | 13 | 4 | 200 | 0.9 | 20 | 2.25 | 2.08 | 5 |
| X | 7 | 1 | 30 | 0.8 | 6 | 1.50 | 2.80 | 30 |
| Y | 8 | 3 | 50 | 1.0 | 0 | 1.25 | 1.88 | ∞ |
| Z | 12 | 12 | 55 | 0.0 | 55 | 0.00 | 1.00 | 0 |

The values for the complexity C and the parallelization probabilities P can be determined by the analysis device 16 shown in FIG. 2, the runtime values tₒ and tₛ can be provided for example by a profiler 13 as shown in FIG. 1 or 2. According to the above examples, the effort values E, the runtimes tₚ, the performance gains S that are to be expected, and the efficiency values F can be calculated taking into account the number of parallel processors and heuristic constants.

Referring to the values given by way of example in Table 1, it is possible to read therefrom that apart from function Y, which has an infinitely high efficiency value F on account of the high parallelization probability P and in particular owing to the absence of effort E, function X, with a comparatively high efficiency value F of 30, comes into consideration as a potential candidate for preferential parallelization. Although the absolute performance gain that is to be expected, expressed for example by the absolute time saving, is higher for function W, in the example in Table 1 function W has a much higher number of lines of code (LoC), which means that the expected investment of time and effort required to parallelize function W will be considerably higher than that for function X. The result for function X is accordingly a cost-benefit ratio of 30, while the cost-benefit ratio for function W only amounts to 5. Function Z in Table 1 will not be considered for software parallelization, because its efficiency value is F=0. The reason for this is that no part of function Z executes in parallel or is able to execute in parallel, thus realizing no time saving, and consequently the expected performance gain S assumes a value of 1 only.

There are of course numerous different possibilities for structuring an output for assessment of a software parallelization. For example, it is possible to choose other calculation formulae containing other complexity criteria and other weightings. It is also possible to select a different scaling for the efficiency values F, or to discretize the output of the efficiency value F, for example by specifying linguistic assessment criteria such as “effort worthwhile”, “effort worthwhile to a degree”, “effort not worthwhile”, or the like.

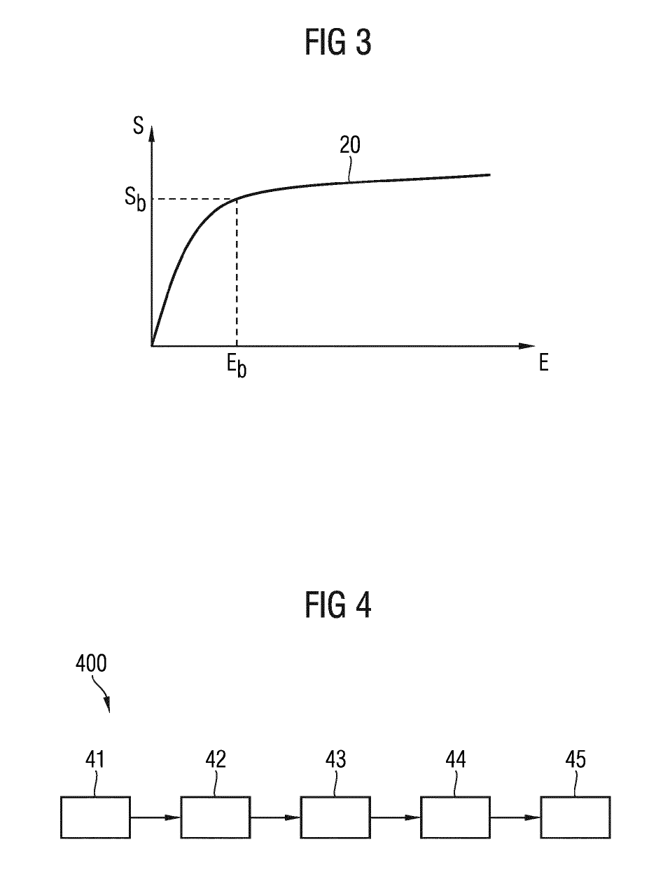

It is also possible to represent the efficiency values in a diagram. An example of such a diagram is shown in FIG. 3. In FIG. 3, the expected performance gains S are plotted as a function of the effort values E. This results in a curve 20 for the efficiency values. In the example shown in FIG. 3 the curve 20 exhibits a kink at a point (E_{b},S_{b}). In the range for E<E_{b}, the performance gain that is to be expected increases significantly more sharply with the effort E than in the range E>E_{b}. This shows that in the example there is hardly any benefit in a software parallelization for code portions or functions having an effort value E that lies above a limit E_{b}. It can for example be provided to exclude such code portions or functions generally from further consideration with regard to their potential as candidates for parallelization.

FIG. 4 shows a schematic diagram illustrating a method 400 for assessing software parallelization. The structure of a software code is analyzed in a first step 41. This can happen for example with the aid of an analysis device 16 as shown in FIG. 2.

In a second step 42 the software code is subdivided into a plurality of code portions based on the structure of the software code. The code portions can in this case be functions, loops, objects, function calls, basic program blocks, program modules, or the like.

In a third step 43 at least one complexity value is determined based on the analysis of the structure of the software code for each of the plurality of code portions. The complexity value can in this case be a complexity value 17 as explained with reference to FIG. 2.

In a fourth step 44 an effort value is determined based on the complexity value for each of the code portions, the effort value indicating the investment of effort required in order to parallelize the code portion. The effort value can in this case be in particular an effort value E as explained in connection with FIG. 2.

In a fifth step 45 an efficiency value is determined for each of the plurality of code portions, the efficiency value rating the efficiency of a parallelization of each of the plurality of code portions based on a ratio between the calculated effort value and a useful value indicating the expected performance gain as a result of the parallelization of the respective code portion. In this case the efficiency value can be an efficiency value F as explained in connection with FIG. 2. An assessment of the software parallelization of the software code can then be undertaken based on the efficiency value. In particular a programmer can use the efficiency values determined in step 45 as a basis for producing a prioritization scheme for the reprogramming of the plurality of code portions.

What is claimed is:

1. A method for assessing software parallelization, the method performed by executing instructions stored in non-transitory computer-readable media using a processor and comprising the steps of:
analyzing a structure of a software code;
subdividing the software code into a plurality of code portions based on the structure of the software code;
determining a complexity value based on the analysis of the structure of the software code for each of the plurality of code portions;
determining an effort value based on the complexity value for each of the code portions, the effort value for each code portion indicating an effort required to parallelize that code portion; and
determining an efficiency value for each of the plurality of code portions, the efficiency value for each code portion rating the efficiency of a parallelization of that code portion based on a ratio between the determined effort value that code portion and a useful value indicating an expected performance gain resulting from the parallelization of that code portion.

2. The method of claim 1, wherein the complexity value comprises a count of the lines of code.

3-5. (canceled)

6. The method of claim 1, wherein the complexity value comprises a cyclomatic complexity value.

7. The method of claim 1, wherein the complexity value comprises a function point analysis value.

8. The method of claim 1, wherein the useful value for each code portion is dependent on a time saving associated with a parallel execution of the respective code portion.

9. The method of claim 1, wherein the useful value for each code portion is dependent on a reduction in latency time associated with a parallel execution of the respective code portion.

10. The method of claim 1, wherein the useful value for each code portion is dependent on a data throughput associated with a parallel execution of the respective code portion.

11. The method of claim 1, wherein the useful value is provided by a profiler.

12. An apparatus for assessing software parallelization comprising:
an analysis device configured to:
analyze a structure of a software code, and
subdivide the software code into a plurality of code portions based on the structure of the software code;
a calculation device configured to:
determine a complexity value based on the structure of the software code for each of the plurality of code portions, and
determine an effort value for each code portion based on the complexity value for that code portion, the effort value for each code portion indicating an effort required in order to parallelize that code portion; and
an assessment device configured to output an efficiency value for each of the plurality of code portions, the efficiency value for each code portion rating the efficiency of a parallelization of that code portion based on a ratio between the determined effort value for each code portion and a useful value indicating an expected performance gain resulting from the parallelization of that code portion,
wherein each of the analysis device, the calculation device, and the assessment device comprises a processor configured to execute instructions stored in non-transitory computer-readable media to perform the respective functions of each respective device.

13. The apparatus of claim 12, wherein the complexity value comprises a count of the lines of code.

14. The apparatus of claim 12, wherein the complexity value comprises a cyclomatic complexity value.

15. The apparatus of claim 12, wherein the complexity value comprises a function point analysis value.

16. The apparatus of claim 12, wherein the useful value for each code portion is dependent on a time saving associated with a parallel execution of the respective code portion.

17. The apparatus of claim 12, wherein the useful value for each code portion is dependent on a reduction in latency time associated with a parallel execution of the respective code portion.

18. The apparatus of claim 12, wherein the useful value for each code portion is dependent on a data throughput associated with a parallel execution of the respective code portion.

19. The apparatus of claim 12, wherein the useful value is provided by a profiler.
